(19) United States
(12) Patent Application Publication
(10) Pub. No.: US 2008/0159154 A1
(43) Pub. Date: Jul. 3, 2008

(54) METHOD AND APPARATUS FOR PROVIDING AUTOMATED PROCESSING OF POINT-TO-POINT PROTOCOL ACCESS ALARMS

(76) Inventors: Paritosh Bajpay, Edison, NJ (US); Roberta Bienfait, Norcross, GA (US); Mojgan Dardashti, Holmdel, NJ (US); Jackson Liu, Middletown, NJ (US); Zhiqiang Qian, Holmdel, NJ (US)

Correspondence Address: AT&T CORP., ROOM 2A207, ONE AT&T WAY, BEDMINSTER, NJ, 07921, US

(21) Appl. No.: 11/618,910

(22) Filed: Jan. 1, 2007

(51) Int. Cl. H04L 12/26

(52) U.S. Cl. 370/245; 370/401

(57) ABSTRACT

A method and apparatus for providing automated processing of point-to-point protocol alarms over Synchronous Digital Hierarchy (SDH) networks are disclosed. For example, the method receives an alarm for a Point-to-Point Protocol (PPP) service over a Synchronous Digital Hierarchy (SDH) network and determines whether said alarm is related to a problem associated with a Layer 2 network, a Layer 3 network, a connectivity between a provider edge router (PER) to a customer edge router (CER). The method then generates a ticket in response to said problem.

The present invention relates generally to communication networks and, more particularly, to a method and apparatus for providing automated processing of point-to-point protocol alarms on packet networks.

### BACKGROUND OF THE INVENTION

An enterprise customer may build a Virtual Private Network (VPN) by connecting multiple sites or users over a network from a telephony service provider. When service degradation occurs, it may be detected by the network service provider or reported by a customer to the network service provider. The network service provider then dispatches maintenance personnel to perform trouble isolation and repair. However, in a large network, the cost of dispatching personnel for each detected and/or reported problem is prohibitive. In addition, the customer may be receiving a degraded service or no service at all while alarms are being collected, analyzed, etc. for trouble isolation and the proper work center is notified to make repairs. The degraded service and delay in performing maintenance affect customer satisfaction.

Therefore, there is a need for a method that provides automatic processing of network alarms.

### SUMMARY OF THE INVENTION

In one embodiment, the present invention discloses a method and apparatus for providing automated processing of point-to-point protocol alarms over Synchronous Digital Hierarchy (SDH) networks. For example, the method receives an alarm for a Point-to-Point Protocol (PPP) service over a Synchronous Digital Hierarchy (SDH) network and determines whether said alarm is related to a problem associated with a Layer 2 network, a Layer 3 network, a connectivity between a provider edge router (PER) to a customer edge router (CER). The method then generates a ticket in response to said problem.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with automated processing of point-to-point protocol alarms over SDH networks;

FIG. 3 illustrates a flowchart of a method for providing automated processing of point-to-point protocol alarms over SDH networks; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing automated processing of point-to-point protocol alarms over Synchronous Digital Hierarchy (SDH) networks. Although the present invention is discussed below in the context of packet networks, the present invention is not so limited. Namely, the present invention can be applied for other networks, e.g. Public Switched Telephone Network (PSTN).

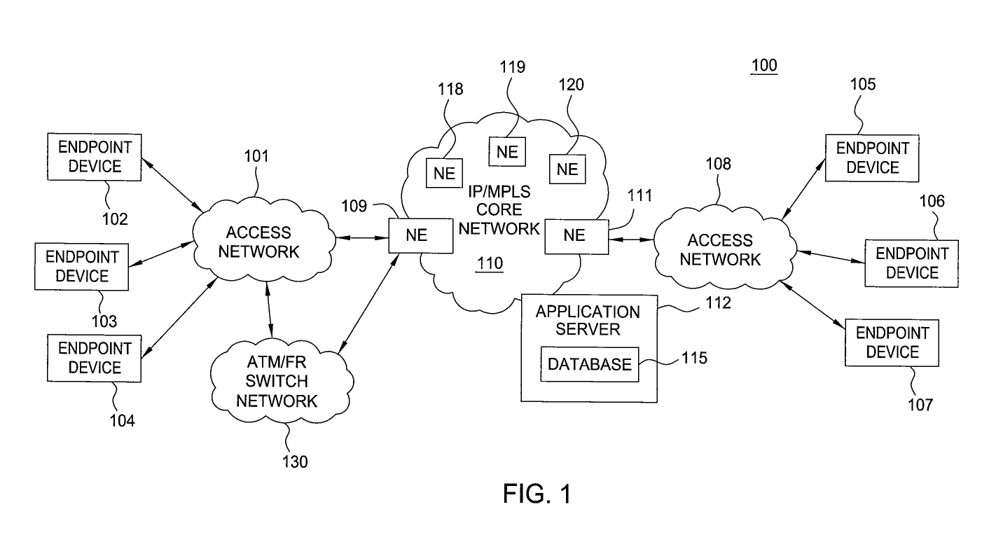

FIG. 1 is a block diagram depicting an exemplary packet network 100 related to the current invention. Exemplary packet networks include Internet protocol (IP) networks, Asynchronous Transfer Mode (ATM) networks, frame-relay networks, and the like. An IP network is broadly defined as a network that uses Internet Protocol such as IPv4 or IPv6 to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like.

The access networks 101 and 108 may be either directly connected to NEs 109 and 111 of the IP/MPLS core network 110 or through an Asynchronous Transfer Mode (ATM) and/or Frame Relay (FR) switch network 130. If the connection is through the ATM/FR network 130, the packets from customer endpoint devices 102-104 (traveling towards the IP/MPLS core network 110) traverse the access network 101 and the ATM/FR switch network 130 and reach the border element 109.

The ATM/FR network 130 contains Layer 2 switches functioning as Provider Edge Routers (PER) and/or Provider Routers (PR). The PERs may also contain an additional Route Processing Module (RPM) that converts Layer 2 frames to Layer 3 Internet Protocol (IP) frames. An RPM enables the transfer of packets from a Layer 2 Permanent Virtual Connection (PVC) circuit to an IP network which is connectionless.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, honeypot, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, and so on are depicted in FIG. 1, the communication system 100 may be expanded by including additional endpoint devices, access networks, border elements, etc. without altering the present invention.

The above IP network is described to provide an illustrative environment in which packets for voice and data services are transmitted on networks. An enterprise customer may build a Virtual Private Network (VPN) by connecting multiple sites or users over a network from a telephony service provider. When service degradation occurs, it may be detected by the network service provider or reported by a customer to the network service provider. The network service provider then dispatches maintenance personnel to perform trouble isolation and repair. However, in a large network, the cost of dispatching personnel for each detected and/or reported problem is prohibitive. In addition, the customer may be receiving a degraded service or no service at all while alarms are being collected, analyzed, etc. for trouble isolation and the proper work center is notified to make repairs. Therefore, there is a need for a method that provides automatic processing of network alarms.

The enterprise VPN may be managed by the network service provider or the customer. A VPN site may have one or more customer endpoint devices connected to a network through a Customer Edge Router (CER) located at the customer premise. The CER is connected to a Provider Edge Router (PER) (on the network service provider's Layer 2 network) through an access network. The access network may comprise a native IP network, a Digital Subscriber Line (DSL) network, a broadband cable access network, a Local Area Network (LAN), a 3^{rd} party ATM network, a Wireless Access Network (WAN), and the like. The customer traffic is then transmitted to the IP/MPLS core network through the Layer 2 network.

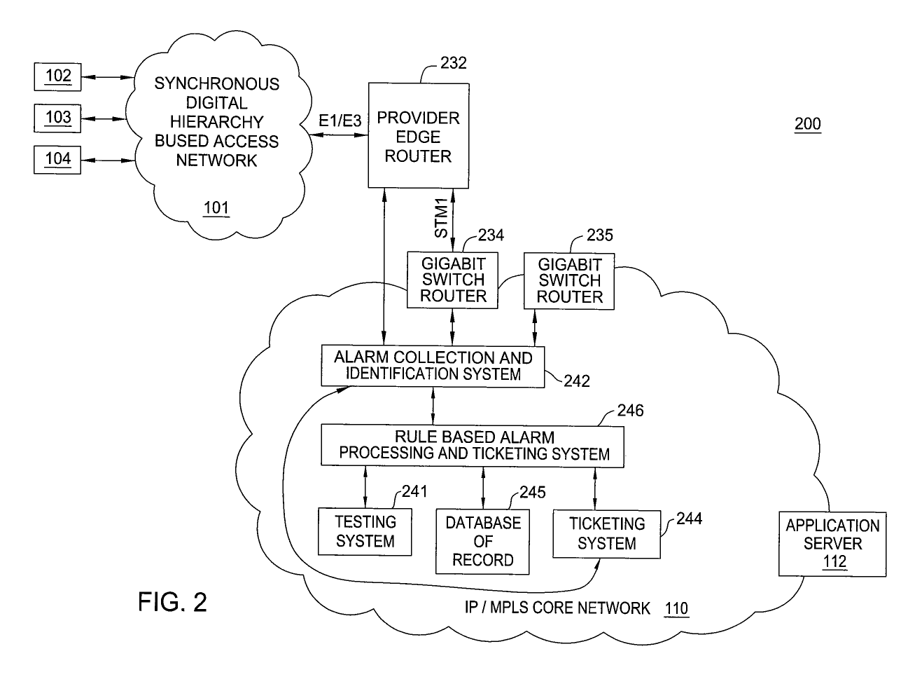

FIG. 2 illustrates an exemplary network 200 with automated processing of Point-to-Point Protocol (PPP) alarms over Synchronous Digital Hierarchy (SDH) networks. PPP refers to a Layer 2 (data-link layer) protocol that enables connectivity to the IP network over a serial line. Customer endpoint devices 102-104 establish a Point-to-Point Protocol (PPP) based connection to an SDH based access network 101. The SDH based access network is connected to the Provider Edge Router (PER) 232 via an E1 or E3 interface. The core network 110 contains the Gigabit switch routers 234 and 235. The PER 232 is connected to a Gigabit switch router 234 located in core network 110 via an STM-1 interface. The core network 110 also includes a testing system 241, an alarm collection and identification system 242, a notification system 243, a ticket generation system 244, a database of record 245, and a rule based alarm processing and ticketing system 246. The rule based alarm processing and ticketing system 246 is connected to the various systems 241-245 for automating processing of network alarms. The application server 112 enables customers to subscribe to services with automated processing of network alarms. The testing system 241 is used for sending test packets and receiving responses. For example, the testing system may send “ping” signal to ports on switches/routers.

The ticket generation system 244 is accessible by customers and service provider personnel. For example, a customer or work center personnel may interact with an Interactive Voice Response (IVR) system and generate a ticket. The ticket may also be created from automatically detected alarms by alarm collection and identification system 242. The alarm collection and identification system 242 is connected to the Gigabit switch routers 234 and 235 and to the PER 232. Similarly, the notification system 243 may be used to notify a customer, or one or more work centers.

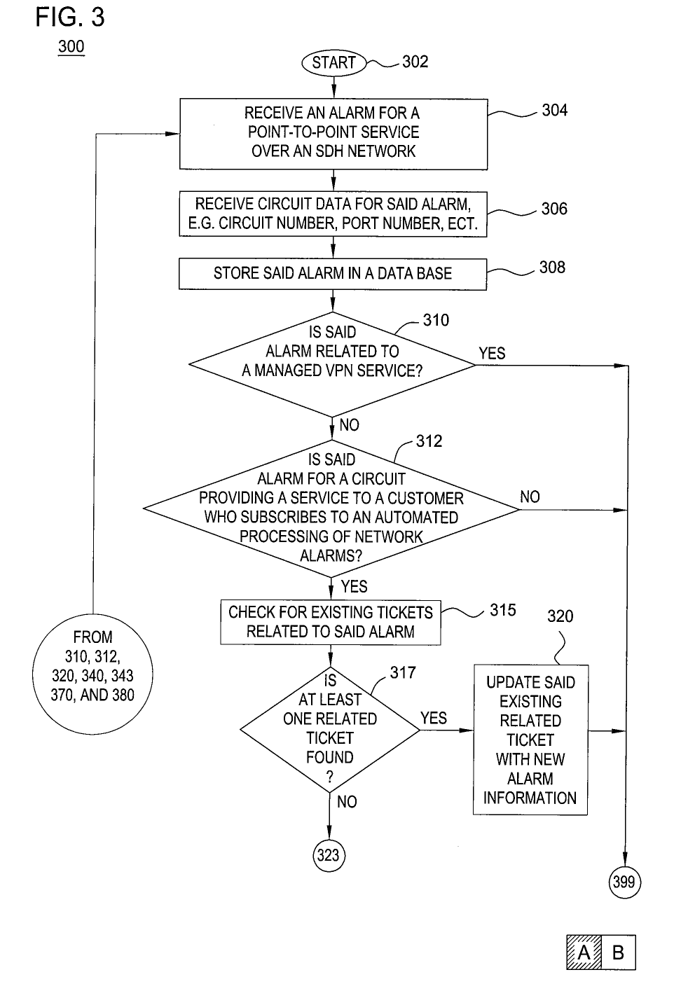

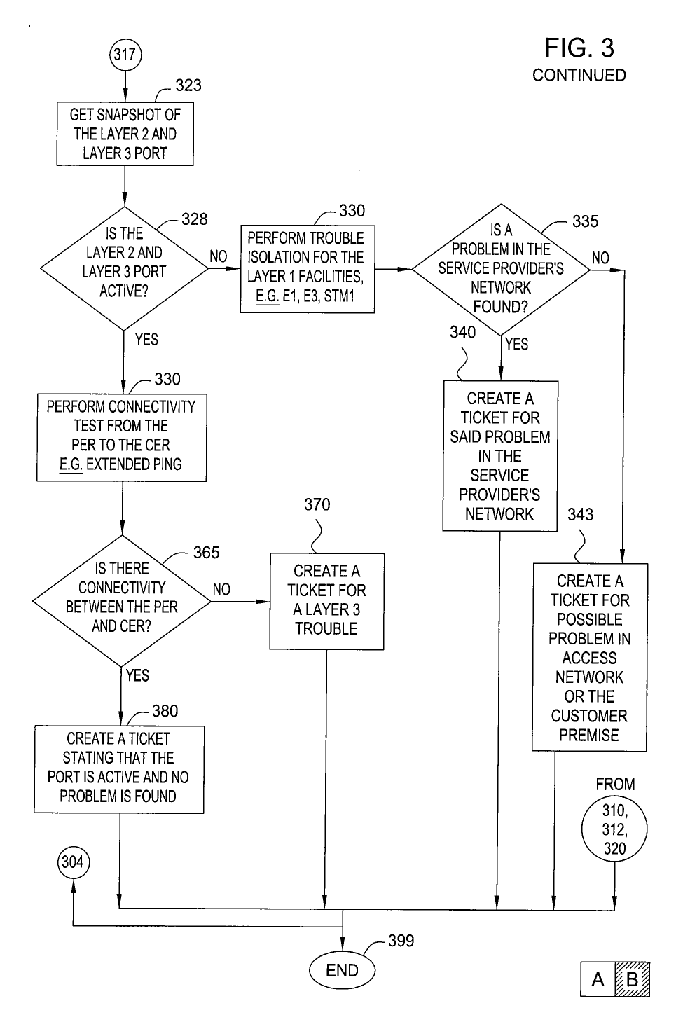

FIG. 3 illustrates a flowchart of a method 300 for providing automated processing of PPP alarms over SDH networks.

Method 300 starts in step 302 and proceeds to step 304.

In step 304, method 300 receives an alarm for a Point-to-Point Protocol (PPP) service over a Synchronous Digital Hierarchy (SDH) access network. For example, an alarm collection and identification system sends an alarm to a rule based alarm processing and ticketing system. The received alarm may include type of alarm, service type, etc.

In step 306, method 300 retrieves circuit data for said alarm. For the example above, the rule based alarm processing and ticketing system accesses a database of record and retrieves circuit identification, port, router identification, service options, etc.

In step 308, method 300 stores said alarm in a database. For example, the rule based alarm processing and ticketing system saves the alarm in an Operation Context (OC). Operation Context refers to a global entity class representing a persistent repository that stores alarm objects.

In step 310, method 300 determines whether or not said alarm is related to a managed VPN service. For example, the alarm may be related to another service and the automated process for alarm processing and ticketing may be for only managed VPN services. If the alarm is related to a managed VPN service, the method proceeds to step 399 to end processing the current alarm and to step 304 to continue receiving new alarms. If the alarm is not related to a managed VPN service, the method proceeds to step 312.

In step 312, method 300 determines whether or not the alarm is for a circuit providing a service to a customer who subscribes to automated processing of network alarms. If the customer subscribes to automated processing of network alarms, the method proceeds to step 315. Otherwise, the method proceeds to step 399 to end processing the current alarm and to step 304 to continue receiving new alarms.

In step 315, method 300 checks for related tickets. For example, a customer may have interacted with an IVR system and may have generated a ticket for a similar problem.

In step 317, method 300 determines whether or not at least one related ticket is found. If a related ticket is found, the method proceeds to step 320. Otherwise, the method proceeds to step 323.

In step 320, method 300 updates the existing related ticket with new alarm information. The method then proceeds to step 399 to end processing the current alarm and to step 304 to continue receiving new alarms.

In step 323, method 300 gets two snapshots of the Layer 2 and Layer 3 port. For example, the method issues a “show” command to determine the status of the port on the PER. The method then waits for a short duration, e.g. 30 seconds, and repeats the “show” command. A response may indicate 800 k bytes received and 600 k bytes transferred in the 30 seconds.

In step 328, method 300 determines whether or not the Layer 2 and Layer 3 port is active. For example, the two snapshots may indicate a fault with the port. If the port is active, the method proceeds to step 360 to perform a connectivity test from the PER to the CER. Otherwise, the method proceeds to step 330.

In step 330, method 300 performs trouble isolation for the Layer 1 facilities, e.g. E1, E3 and STM1 facilities. The method may perform tests for each facility providing service to the customer. The method then proceeds to step 335.

In step 335, method 300 determines whether or not a problem in the service provider's network is found. For example, the method determines whether or not a Layer 1 facility problem is found. If a problem in the service provider's network is found, the method proceeds to step 340. Otherwise, the method proceeds to step 343.

In step 340, method 300 creates a ticket for said problem in the service provider's network, e.g. Layer 1 problem. The method then proceeds to step 399 to end processing the current alarm and to step 304 to continue receiving new alarms.

In step 343, method 300 creates a ticket for possible failure in said SDH access network or customer premise. The method then proceeds to step 399 to end processing the current alarm and to step 304 to continue receiving new alarms.

In step 360, method 300 performs connectivity test between the PER and the Customer Edge Router (CER). In one embodiment, the method performs connectivity test between the PER and CER using an extended ping command. An extended ping refers to a “ping” command with 3 patterns instead of the traditional “ping” that has one pattern. The method then proceeds to step 365.

In step 365, method 300 determines whether or not there exists connectivity between the PER and the CER. If the connectivity between the PER and the CER is active, the method proceeds to step 380. Otherwise, the method proceeds to step 370.

In step 370, method 300 creates a ticket for a layer 3 trouble. For example, the method may create a ticket stating that the extended ping test for connectivity between the PER and the CER has resulted in a failure and trouble may be Layer 3 related. The method then proceeds to step 399 to end processing the current alarm and to step 304 to continue receiving new alarms.

In step 380, method 300 creates a ticket stating that the port is active and no problem is found. For example, the automated method for alarm processing may not have identified any problem. A technician may have to perform further analysis. The method then proceeds to step 399 to end processing the current alarm and to step 304 to continue receiving new alarms.

Method 300 ends in step 399.

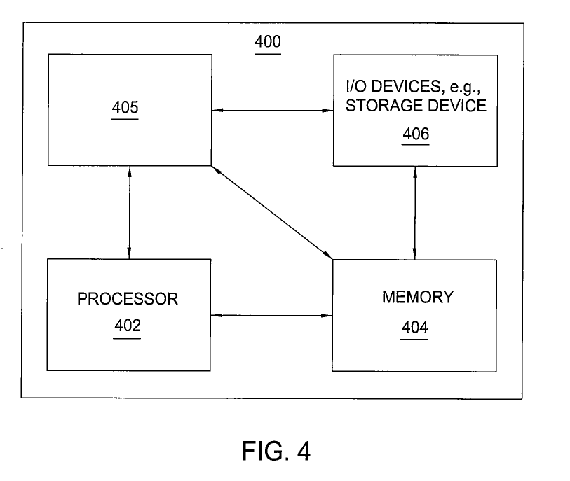

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing automated processing of alarms for Point-to-Point Protocol (PPP) service over a Synchronous Digital Hierarchy (SDH) access networks, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing automated processing of alarms for PPP service over a SDH access networks can be loaded into memory 404 and executed by processor 402 to implement the functions as discussed above. As such, the present method 405 for providing automated processing of alarms for PPP service over a SDH access networks (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing automated processing of alarms for Point-to-Point Protocol (PPP) service over a Synchronous Digital Hierarchy (SDH) access network comprising:
receiving an alarm for a Point-to-Point Protocol (PPP) service over a Synchronous Digital Hierarchy (SDH) network;
determining whether said alarm is related to a problem associated with a Layer 2 network, a Layer 3 network, a connectivity between a provider edge router (PER) to a customer edge router (CER); and
generating a ticket in response to said problem.

2. The method of claim 1, wherein said determining whether said alarm is related to a problem associated with said Layer 2 network or said Layer 3 network comprises:
determining whether or not a Layer 2 port and Layer 3 port on said Provider Edge Router (PER) is active; and
isolating said problem to a service provider network or a failure in said SDH network or a customer premise if said Layer 2 and Layer 3 port is active.

3. The method of claim 2, wherein said determining whether said alarm is related to a problem associated with said connectivity between said provider edge router (PER) to said customer edge router (CER) comprises:
determining whether or not there is connectivity between the Provider Edge Router (PER) and the Customer Edge Router (CER).

4. The method of claim 1, further comprising:
determining circuit data for said alarm comprising at least one of: a circuit identification, a port number, a router identification, or a service option.

5. The method of claim 1, further comprising:
determining whether or not at least one existing related ticket is found; and
updating said existing related ticket with new alarm information.

6. The method of claim 1, wherein said Point-to-Point Protocol (PPP) service is related to a managed service.

7. The method of claim 1, wherein said alarm is for a customer that has subscribed to a service with an automated processing of network alarms.

8. A computer-readable medium having stored thereon a plurality of instructions, the plurality of instructions including instructions which, when executed by a processor, cause the processor to perform the steps of a method for providing automated processing of alarms for Point-to-Point Protocol (PPP) service over a Synchronous Digital Hierarchy (SDH) access network, comprising:
receiving an alarm for a Point-to-Point Protocol (PPP) service over a Synchronous Digital Hierarchy (SDH) network;
determining whether said alarm is related to a problem associated with a Layer 2 network, a Layer 3 network, a connectivity between a provider edge router (PER) to a customer edge router (CER); and
generating a ticket in response to said problem.

9. The computer-readable medium of claim 8, wherein said determining whether said alarm is related to a problem associated with said Layer 2 network or said Layer 3 network comprises:
determining whether or not a Layer 2 port and Layer 3 port on said Provider Edge Router (PER) is active; and
isolating said problem to a service provider network or a failure in said SDH network or a customer premise if said Layer 2 and Layer 3 port is active.

10. The computer-readable medium of claim 9, wherein said determining whether said alarm is related to a problem associated with said connectivity between said provider edge router (PER) to said customer edge router (CER) comprises:
determining whether or not there is connectivity between the Provider Edge Router (PER) and the Customer Edge Router (CER).

11. The computer-readable medium of claim 8, further comprising:
determining circuit data for said alarm comprising at least one of: a circuit identification, a port number, a router identification, or a service option.

12. The computer-readable medium of claim 8, further comprising:
determining whether or not at least one existing related ticket is found; and
updating said existing related ticket with new alarm information.

13. The computer-readable medium of claim 8, wherein said Point-to-Point Protocol (PPP) service is related to a managed service.

14. The computer-readable medium of claim 8, wherein said alarm is for a customer that has subscribed to a service with an automated processing of network alarms.

15. An apparatus for providing automated processing of alarms for Point-to-Point Protocol (PPP) service over a Synchronous Digital Hierarchy (SDH) access network comprising:
means for receiving an alarm for a Point-to-Point Protocol (PPP) service over a Synchronous Digital Hierarchy (SDH) network;
means for determining whether said alarm is related to a problem associated with a Layer 2 network, a Layer 3 network, a connectivity between a provider edge router (PER) to a customer edge router (CER); and
means for generating a ticket in response to said problem.

16. The apparatus of claim 15, wherein said determining means determines whether said alarm is related to a problem associated with said Layer 2 network or said Layer 3 network by determining whether or not a Layer 2 port and Layer 3 port on said Provider Edge Router (PER) is active and by isolating said problem to a service provider network or a failure in said SDH network or a customer premise if said Layer 2 and Layer 3 port is active.

17. The apparatus of claim 16, wherein said determining means determines whether said alarm is related to a problem associated with said connectivity between said provider edge router (PER) to said customer edge router (CER) by determining whether or not there is connectivity between the Provider Edge Router (PER) and the Customer Edge Router (CER).

18. The apparatus of claim 15, further comprising:
means for determining circuit data for said alarm comprising at least one of: a circuit identification, a port number, a router identification, or a service option.

19. The apparatus of claim 15, further comprising:
means for determining whether or not at least one existing related ticket is found; and
means for updating said existing related ticket with new alarm information.

20. The apparatus of claim 15, wherein said Point-to-Point Protocol (PPP) service is related to a managed service.
